(19) United States
(12) Patent Application Publication
(10) Pub. No.: US 2010/0128636 A1
(43) Pub. Date: May 27, 2010

(54) SENSOR NETWORK WITH RAPID, INTUITIVE CONFIGURATION

(76) Inventors: Patrick Seeling, Stevens Point, WI (US); Justin Starren, Marshfield, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/617,745

(22) Filed: Nov. 13, 2009

Related U.S. Application Data
(60) Provisional application No. 61/117,817, filed on Nov. 25, 2008.

(51) Int. Cl. H04L 12/28

(52) U.S. Cl. 370/254

(57) ABSTRACT

A network system for obtaining monitoring information from a patient that includes one or more sensing devices is disclosed. The network is configured by positioning a parent node and a child node within close proximity to each other. An input device on each of the parent and child nodes is actuated to begin an association procedure. When the parent and child devices are within a close proximity to each other, the child device becomes associated with the parent device. Various techniques for determining the proximity of the parent device to the child device are possible to ensure the correct association between the child device and the parent device.

### CROSS-REFERENCE TO RELATED APPLICATION

This application is based on and claims priority from U.S. Provisional Patent Application Ser. No. 61/117,817 filed on Nov. 25, 2008.

### BACKGROUND

The present disclosure generally relates to wireless networks of sensors and in particular to a method of configuring such a network that is procedurally simple and that works with sensors having reduced hardware configurations.

Significant progress has been made monitoring patients in a bedside setting using electronic sensors. Such sensors, by providing continuous monitoring of the patient, in contrast to periodic monitoring by a nurse or physician, can greatly improve the outcomes of medical treatment by providing better and faster data in response to potentially serious medical conditions.

Using electronic sensors to monitor ambulatory patients either within a hospital or a home setting has proven to be much more difficult. While generally the sensors can be sufficiently compact and lightweight to move with the patient, the wiring harness necessary to collect the data from the sensors and to communicate the collected data to a remote monitoring station is cumbersome and unacceptably reduces the freedom of movement of the patient.

For this reason, it has been proposed to use wireless transmission to connect electronic medical sensors to a remote monitoring station. One attractive protocol for such a system is the ZigBee IEEE 802.15.4 network standard which provides for end devices having extremely simple hardware requirements with a protocol designed for long battery life. Such end devices could potentially be used to provide wireless communication not only between the patient and a remote station but also between the individual sensors themselves. This latter approach would allow each sensor to be freely and individually attached or removed from the patient without the need for a wiring harness or the like.

While such a wireless network provides great freedom in using biosensors attached to a mobile patient, wireless networks are not without drawbacks, most notably of which is the complexity of configuring a network where connections are not defined by physical wires. While the ZigBee protocol allows for a nearly automatic connection of end devices to other devices by seeking out strong connections providing the least network depth, this approach of automatic connection may not be practical in a hospital environment where multiple devices and multiple similar networks in close proximity are associated with different patients and where strict network communication boundaries must be enforced between patients. That is, in a typical hospital environment, a given ZigBee end device should not be free to connect across patient clusters, since such a connection might confusingly associate medical data for one patient with another patient.

One method of enforcing network topologies is to preconfigure the router or coordinator device with the hardware addresses (MAC addresses) of the other devices to which they should connect. In this way the network connections, being predefined, insure integrity of the transmitted data. However, such preconfiguration is time consuming and rather inflexible.

### SUMMARY

Although such a wireless network of independent biosensors is currently possible, its acceptance may be severely curtailed by the difficulties of network configuration by an inexperienced home user or a busy healthcare practitioner. As one possible solution, the present disclosure provides a simplified network configuration using an intuitive paradigm of touching devices together to make a connection. A button pressed on the devices when they are in proximity completes the connections so that the devices may be withdrawn while retaining the connection and ignoring potential connections with other devices. To the user, the touching process connects an invisible string between the devices that holds them in communication regardless of how they are separated. As well as providing an understandable connection metaphor (physical touching), this connection method can be performed with extremely rudimentary hardware devices that do not have keypads or display screens for the entry and confirmation of numeric data.

In one embodiment, the touching of the devices may be detected by monitoring the carrier signal between the devices thus eliminating the need for additional hardware for proximity sensing and making use of native instructions available in the ZigBee standard. A variety of other proximity sensing techniques and implementation of a button pressing also may be used.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a simplified representation of an ambulatory patient having a variety of ZigBee end devices independently attached to the patient and communicating wirelessly with a router and or coordinator device to connect with a remote station;

FIG. 2 is a block diagram of two inter-communicating ZigBee devices having external buttons used for establishing a network connection when the devices are in proximity;

FIG. 3 is a graph showing a carrier signal strength as a function of distance and showing transmission range, proximity range, and defined transmitter peak power;

FIG. 4 is a pair of flow charts implementing the present disclosure on a ZigBee parent and child device to create a network connection between the two devices; and

FIGS. 5-7 are fragmentary portions of the block diagram of FIG. 2 showing other proximity sensing techniques including bar codes, RFID tags, and an acoustic contact sensing using an accelerometer.

### DETAILED DESCRIPTION OF THE PREFERRED EMBODIMENTS

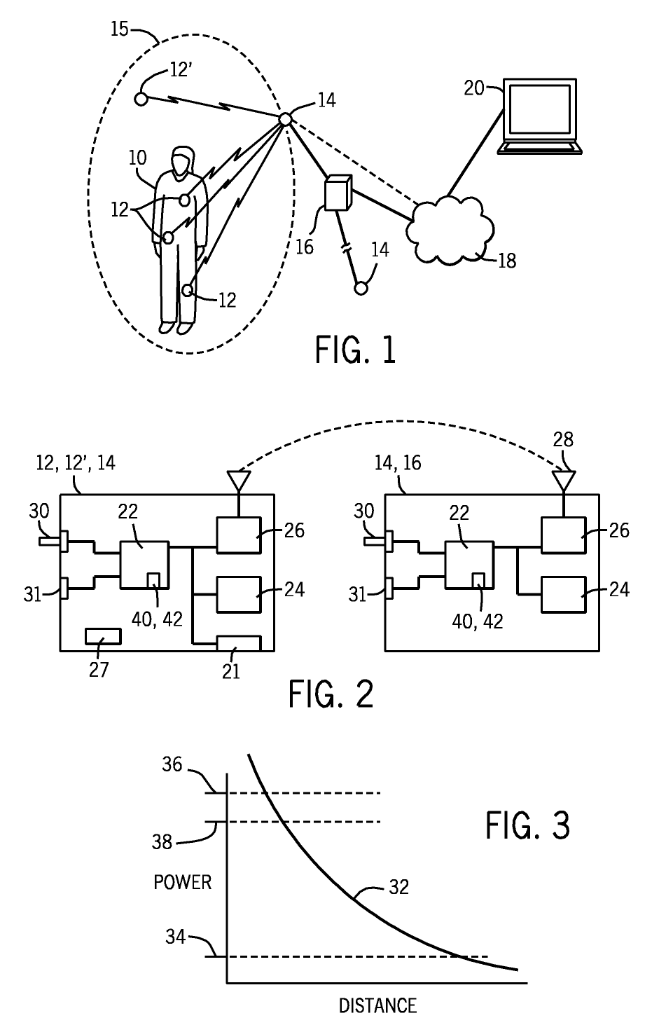

Referring now to FIG. 1, an ambulatory patient 10 may have a variety of directly attached nodes (DANs) 12 that each include a ZigBee end device including one or more biosensors that monitor biosignals from the patient 10. The DANs 12 communicate with a personal area coordinator (PAC) 14, for example, incorporating a ZigBee router. The PAC 14 may also communicate with one or more personal environmental nodes (PENs) 12′, that each include a ZigBee end device having a sensor or sensors to sense the environment around the patient but not attached to the patient 10.

The DANs 12 may include, for example, end devices having sensors of body temperature, heart rate, ECG values, or blood oxygen levels. The PENs 12′ may, for example, include end devices that provide sensors associated with equipment such as scales, blood pressure cuffs, or blood glucose meters, that also provide information about the patient 10 but which are not physically attached to the patient for an extended period of time. The PENs 12′ may alternatively or in addition provide general environmental sensors detecting light level, humidity level, ambient temperature, or environmental noise in the area near the patient 10.

In the embodiment shown in FIG. 1, the PAC 14 creates a network within the personal area 15 generally surrounding the patient 10. The PAC 14 generally gathers information from the DANs 12 and PENs 12′ that are members of the PAC created network within the personal area 15. The PAC 14 is configured to receive information from the DANs 12 as well as send out a network signal that can be received by the DANs 12.

If a home monitoring application scenario is considered with respect to FIG. 1, the separation between personal and environmental monitoring becomes more obvious. While environmental data can be sent without encryption, patient-sensitive health data should not be transmitted from the PAC 14 without encryption. Thus, when the network of FIG. 1 is utilized with a home monitoring application, the PAC 14 must allow for encrypted storage, analysis, and forwarding of patient data to a home healthcare provider.

In addition, in such a home monitoring application, it is desirable to allow for the ad-hoc association of individual end devices (DAN 12 and PEN 12′) to allow for easy setup of a network. In a general application scenario, the users of the network must be assumed to have no detailed knowledge of the network functionalities or extended technical knowledge. It is thus desirable to allow for easy association between the end devices of the DANs 12 and the personal area coordinator 14. This will enable users to be monitored in their own home and to add and remove devices in the monitoring network.

Note that it is important that the particular DANs 12 and PENs 12′ be associated with a particular PAC 14 and thus be topologically locked to the patient's network created by the PAC 14 to prevent cross sharing of information between patients.

The PAC 14 may in turn be connected to a general area gateway (GAG) 16 incorporating a ZigBee coordinator and having substantially greater computational powers for preprocessing of the data for a given patient, for example, to format it with a patient identification number or the like. The GAG 16 may, for example, provide for a conventional terminal connection allowing the inputting of data or the like and may provide a non-ZigBee connection to a local network 18 and thus access to a remote monitoring station 20. The GAG 16 can be configured to collect and process data from different PACs 14. As an example, in a hospital environment, the GAG 16 could be at the nurses' station and could be connected to the network 18 either wirelessly or through a wired connection. The GAG 16 would receive patient information from multiple PACs 14 as shown. The remote monitoring station 20 may monitor data from multiple patients 10 and may provide for an internal rules engine or the like establishing automatic rules to alert a nurse or other caregiver with respect to information obtained from sensors associated with one or more of the DANs 12.

Referring now to FIG. 2, a parent device and child device, for example a DAN 12 and PAC 14 that may be connected together on a wireless network, provide similar architectures including, for example, a processor 22 communicating with a memory 24 containing stored programs (40, 42) implementing the network connection process of the present disclosure as well as general features of the device including the ZigBee stack. Generally each DAN 12 will have a battery 27 such that the end device of the DAN 12 can be completely untethered from electrical power cords or the like while the PACs 14 and GAGs 16 may have dedicated connections to a power line. The DANs 12 include a biomonitoring electronic sensor 21 of the type described above.

The processor 22 of the ZigBee devices may communicate with a wireless transceiver 26 having an antenna 28 for providing radio communications according to the ZigBee standard. In the present disclosure, processor 22 may also connect with an input device 30, such as an electrical switch or push button, providing an extremely simplified user interface on the DAN 12, PAC 14, and GAG 16 used in the present disclosure. A signaling device 31 such as an LED indicator or audio transducer may also be provided. In a typical commercial implementation of the DANs 12, the processor 22, transceiver 26 and memory 24 will be a single integrated circuit providing a lightweight and compact hardware implementation.

Referring now to FIG. 3, the ZigBee standard follows an underlying IEEE 802.15.4 specification and provides the ability of software monitoring of radio carrier signal strength 32 received at the antenna 28 of each of the nodes 12. In other words, the processor 22 running the stored program 40, 42 may query the signal strength of any carrier received from the transceiver 26. The peak power level 36 of the carrier signal 32 at a predetermined distance from the device is well-defined by the standard. Generally, as long as carrier signal strength is above a transmission threshold 34, the devices 12, 14, and 16 may communicate with each other.

The strength of the carrier signal 32 will generally rise in a power-law relationship as distance between two communicating devices 12, 14, or 16 is decreased. Thus, a proximity threshold 38 may be established such that when the strength of the carrier signal 32 exceeds the proximity threshold 38, the strength of the carrier signal indicates an extremely close proximity of the devices, for example less than 10 cm. This close proximity is much less than the 10 to 75 m transmission range of the devices. It is possible to define a single proximity threshold 38 that indicates close proximity for devices 12, 14, 16 even operating at different peak powers, as a result of this power-law relationship.

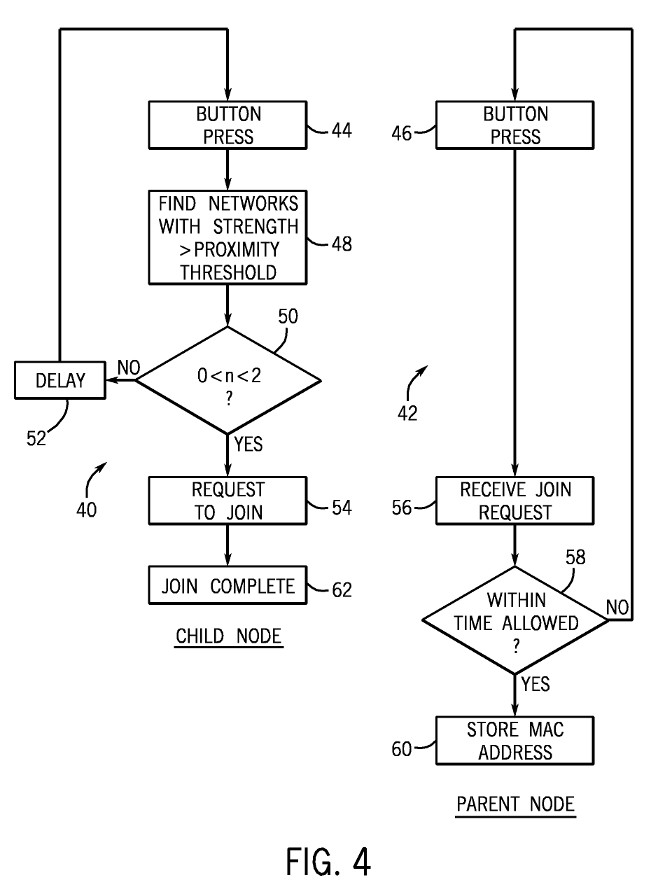

Referring now to FIG. 4, two devices, for example a DAN 12 as a child device and a PAC 14 as a parent device, may be logically connected together in the network according to a protocol implemented by programs 40 running on the DAN 12 and programs 42 running on the PAC 14, for example. Although FIG. 4 is described as the protocol between one of the DANs 12 and the PAC 14, a similar protocol may be performed between PAC 14 as a child device and GAG 16 as a parent device. Logical connection means that the devices are in fact capable of exchanging data and are independent of whether they can in fact receive each other's radio transmissions.

In order to implement the connection, the parent and child devices are initially brought together to touch and preferably so as to be within approximately 10 cm of each other. Once in this close proximity, the input devices 30 on each of the devices, such as the push buttons shown in FIG. 2, are pressed as indicated by process blocks 44 and 46. Prior to the button on the end device of the PAC 14 being depressed, the device of the PAC 14 is operating in a state that prevents joining of new nodes to the network. The button pressing on the parent PAC 14 places it in a condition to receive join requests within a predetermined period of time, for example, one minute.

The button press 44 on the child DAN 12 triggers the ZigBee stack to execute a scan to find networks in the neighborhood of the DAN 12 having a carrier signal strength exceeding the proximity threshold 38, as indicated by process block 48. If at decision block 50 no network (n) or more than one network meeting this criterion are found, then the program 40 waits for a random time 52. During this delay, the end device of the DAN 12 optionally signals the user by means of the signaling device 31. The user is then prompted to actuate the input device 30 again if desired.

If at decision block 50 only one network is found having a network carrier signal that exceeds the proximity threshold, a request to join is made by the child DAN 12, as indicated by process block 54. The request to join is received on the parent PAC 14, as indicated by process block 56. If the request to join is received by the parent PAC 14 within the predetermined time, as determined by decision block 58, the MAC addresses of the child DAN 12 is recorded by the parent PAC 14 and stored as indicated by process block 60 creating a persistent connection that survives as the devices are separated and the carrier signal strength 32 drops below the proximity threshold 38.

If in decision block 50 the DAN 12 determines that more than one suitable network was located, the system also proceeds to block 52 where a random time is allowed to expire before the program again returns to step 44 to determine whether the input device on the child device has been actuated. When the child DAN 12 senses more than one network in the immediate vicinity, the end device of the DAN 12 returns to monitoring for activation of the input device which should allow simultaneous ongoing association procedures in the vicinity of the node under consideration. Preferably, the DAN 12 will provide an indication to the user of this state, such as through an LED, so that the user can repeat the association procedure by depressing the button in step 44.

The process, from the point of view of the user, requires only a simple holding together of the devices to be connected while actuating the input device 30 on each device at approximately the same time.

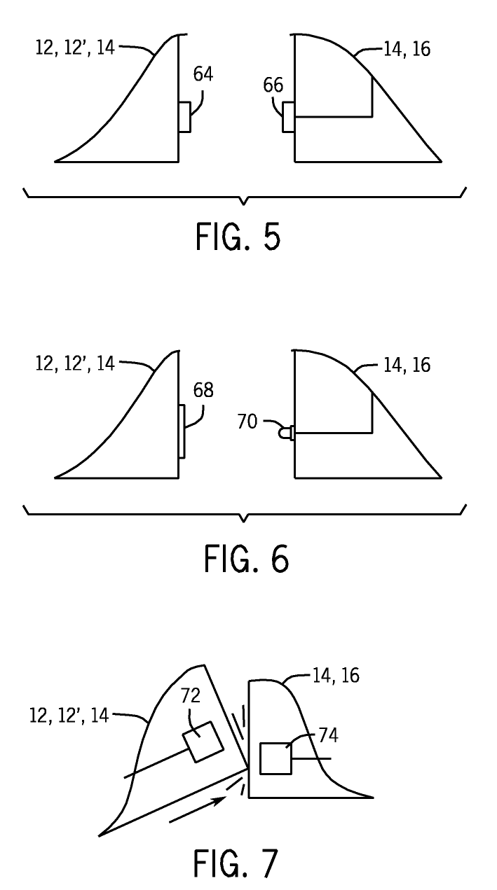

Referring now to FIG. 5, the above embodiment provides an extremely simple hardware configuration, however it will be appreciated that the button pressing function and proximity sensing function may be accomplished in a variety of other ways. For example, the child DAN 12 may include an RFID tag 64 such as may be read by a reader 66 on the parent PAC 14. The local operation of such readers 66 can provide both a proximity signal and an effective button pressing or maybe augmented by a separate button press.

Referring to FIG. 6, in an alternative embodiment, the child DAN 12 may have a barcode 68 and a barcode reader 70 may be on the parent PAC 14 to provide proximity sensing and a button pressing or to be used with independent button pressing. A similar approach (not shown) may make use of an electrical connector which physically connects the two devices providing both indication of proximity and the desire to connect the devices normally provided by the button pressings.

Referring to FIG. 7, an acoustic transducer or accelerometer 72 in the child DAN 12 and the parent PAC 14 may sense a proximity inferred from high-frequency signals from the accelerometer 72 caused by a tapping of the two devices together. These proximity signals in conjunction with the button pressing may establish the connection of the present invention.

Alternatively, other proximity sensing techniques may be used including, for example, the direct electrical connection of two external metal parts on the housings of the devices (to be distinguished from the electrical connector described above). With either of these electrical connection techniques, the fact of connection may signal proximity and promote the connection process like a button-press, but may also communicate a signal between the devices for other purposes. In an alternative embodiment, the proximity sensing may be an LED, for example, producing a predetermined coded or frequency-modulated signal to be detected by a sensor on the other unit. Again identification of the signal may indicate proximity but the signal may also communicate data.

An alternative proximity sensor may be provided through a low-frequency magnetic field transmission, or standard low powered RF transmissions through-body from a dedicated transmitter used solely for proximity detection. This latter technique, may use the patient's body as an antenna, allowing a network to be configured by proximity, per the present invention, where the proximity is defined by the personal space of the patient for an extremely intuitive association of network devices related to a patient. None of these proximity detecting techniques should be considered to exclude others known in the art.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

Various alternatives and embodiments are contemplated as being within the scope of the following claims particularly pointing out and distinctly claiming the subject matter regarded as the invention.

I claim:

1. A method of configuring a network providing wireless communication between multiple dispersed nodes over a radio carrier signal, comprising the steps of:
positioning a first node and a second node within a predetermined distance from each other;
detecting at the first node and the strength of the radio carrier signal from the second node;
making a logical connection between the first node and the second node if the strength of the radio carrier signal from the second node is above a predetermined threshold thereby indicating that the first and second nodes are within the predetermined distance; and
communicating data between the first and second nodes at a distance greater than the predetermined distance.

2. The method of claim 1 wherein the second node is a network node that communicates with a plurality of nodes including the first node.

3. The method of claim 1 wherein the first node communicates with only the second node after the logical connection is made between the first and second nodes.

4. The method of claim 1 further comprising the step of retrieving an address associated with the first node in the second node.

5. The method of claim 1 wherein the step of detecting includes the steps of:
actuating a first input device on the first node; and
actuating a second input device on the second node, wherein the logical connection between the first and second nodes occurs only after depression of the first and second input devices.

6. The method of claim 5 wherein the first and second input devices are push buttons.

7. A method of creating a wireless network association between at least a parent node and a plurality of child nodes that communicate over a radio carrier signal, comprising the steps of:
positioning the parent node and the child node within a predetermined distance from each other;
nearly simultaneously actuating a first input device on the parent node and a second input device on the child node to begin an association procedure;
operating the child node to detect a network signal from the parent node;
upon detecting the network signal from the parent node, issuing a request to join the network from the child node;
receiving the request to join the network at the parent node; and
creating a logical connection between the parent node and the child node such that the child node is associated with the network of the parent node.

8. The method of claim 7 wherein each of the child nodes includes an end device operable to sense biosignals from a patient.

9. The method of claim 8 wherein at least one of the child nodes includes an end device operable to detect environmental conditions near the patient.

10. The method of claim 7 wherein the child node detects the strength of the radio carrier network signal from the parent node and generates the request to join the network only when the detected network strength exceeds a predetermined threshold.

11. The method of claim 10 wherein the detected strength of the network signal exceeds the predetermined threshold only when the parent node and the child node are closer than the predetermined distance.

12. The method of claim 10 wherein the logical connection between the parent node and the child node is created only when the child node detects only a single network signal having a strength above the predetermined threshold.

13. The method of claim 7 wherein the parent node monitors for the receipt of the request to join only for a predetermined monitoring period following depression of the first activation button.

14. The method of claim 8 wherein each end device is self-contained and includes a battery such that the end device can be attached to the patient.

15. A wireless network for obtaining data from a patient, comprising:
at least one personal area coordinator (PAC) configured to create the wireless network and communicate over a local network, the PAC including an input device; and
a plurality of sensing nodes each having at least one sensor for monitoring biosignals from the patient, a wireless communication device, and an input device,
wherein the sensing nodes are associated with the PAC upon simultaneous actuation of the input device on the PAC and the sensing node when the sensing node is within a predetermined distance from the PAC.

16. The wireless network of claim 15 further comprising at least one environmental sensing node having at least one sensor for monitoring environmental conditions near the patient.

17. A method of creating a wireless network association between at least a parent node and a child node that communicates over a radio carrier signal, comprising the steps of:
positioning the parent node and the child node within a predetermined distance from each other;
nearly simultaneously actuating a first input device on the parent node and a second input device on the child node to begin an association procedure;
operating a detector on the parent node to retrieve network information from the child node; and
creating a logical connection between the parent node and the child node such that the child node is associated with the network of the parent node.

18. The method of claim 17 wherein the detector on the parent node is an RFID detector and the child node includes an RFID tag, wherein the RFID detector can sense the RFID tag only when the child node is within the predetermined distance from the parent node.

19. The method of claim 17 wherein the detector on the parent node is an bar code reader and the child node includes an bar code, wherein the bar code reader can sense the bar code only when the child node is within the predetermined distance from the parent node.
